(19) United States
(12) Patent Application Publication
(10) Pub. No.: US 2015/0177686 A1
(43) Pub. Date: Jun. 25, 2015

(54) HOLOGRAM RECORDING APPARATUS AND METHOD FOR RECORDING HOLOGRAPHIC ELEMENT IMAGES USING SPATIAL LIGHT MODULATOR (SLM)

(71) Applicant: Electronics and Telecommunications Research Institute, Daejeon (KR)

(72) Inventors: Bong Ho LEE, Daejeon (KR); Tae One KIM, Daejeon (KR); Hyon Gon CHOO, Daejeon (KR); Kwan Jung OH, Daejeon (KR); Kyung Ae MOON, Daejeon (KR); Jin Woong KIM, Daejeon (KR)

(21) Appl. No.: 14/575,354

(22) Filed: Dec. 18, 2014

(30) Foreign Application Priority Data
Dec. 19, 2013 (KR) 10-2013-0159496

(51) Int. Cl. G03H 1/08

(52) U.S. Cl. CPC G03H 1/08

(57) ABSTRACT

Provided is an apparatus and method for recording holographic element images using a spatial light modulator (SLM), the apparatus including a recording light source unit to split a source beam output from a light source into a first output beam and a second output beam and output the first output beam and the second output beam, a reference beam generator to eliminate a distortion of the first output beam, and generate a reference beam by controlling a size and a shape of the distortion-eliminated first output beam, an object beam generator to generate an object beam by eliminating a distortion of the second output beam, and an object beam converging lens system to output a signal beam by modulating an object beam using a holographic element image, split the output signal beam in a plurality of directions, and converge split signal beams to be incident to a hologram film.

### CROSS-REFERENCE TO RELATED APPLICATION

This application claims the benefit of Korean Patent Application No. 10-2013-0159496, filed on Dec. 19, 2013, in the Korean Intellectual Property Office, the disclosure of which is incorporated herein by reference.

### BACKGROUND

1. Field of the Invention

Embodiments of the present invention relate to an apparatus and method that may record holographic element images using a spatial light modulator (SLM).

2. Description of the Related Art

Among existing methods of recording a hologram on a hologram film, a digital recording method refers to a method of generating an interference pattern for each holographic element, which is a small unit.

The digital recording method may record a single holographic element using a single spatial light modulator (SLM). To record a plurality of holographic elements simultaneously using the existing digital recording method, SLMs corresponding to a number of holographic elements to be recorded simultaneously may be required and thus, a cost for a hologram recording apparatus may increase.

Herein, an apparatus and method that may record a plurality of holographic elements simultaneously without an increase in cost will be described.

### SUMMARY

An aspect of the present invention provides an apparatus and method that may record a plurality of holographic element images on a hologram film using a single spatial light modulator (SLM).

According to an aspect of the present invention, there is provided a hologram recording apparatus of a hologram recording apparatus including an SLM to output a signal beam by modulating an object beam using a plurality of holographic element images, a polarized beam splitter (PBS) to transmit the object beam to the SLM, a beam splitter (BS) to split the output signal beam in a plurality of directions, a relay lens to control sizes of signal beams split by the BS, and a converging lens to converge the size-controlled signal beams to be incident to a hologram film.

The BS may split the output signal beam based on the plurality of holographic element images.

The BS may split the output signal beam in four directions except for an optical axis along which the output signal beam proceeds.

The BS splits the output signal beam in two directions except for an optical axis along which the output signal beam proceeds.

The hologram recording apparatus may further include a first additional BS to split one of the signal beams split by the BS in different directions; and a second additional BS to split another of the signal beams split by the BS in different directions.

According to another aspect of the present invention, there is also provided a hologram recording apparatus comprising including an SLM to output a signal beam by modulating object beam using a plurality of holographic element images, a BS to split the output signal beam in a plurality of directions, a relay lens to control sizes of signal beams split by the BS, and a converging lens to converge the size-controlled signal beams to be incident to a hologram film.

According to still another aspect of the present invention, there is also provided a hologram recording apparatus including a recording light source unit to split a source beam output from a light source into a first output beam and a second output beam and output the first output beam and the second output beam, a reference beam generator to eliminate a distortion of the first output beam, and generate a reference beam by controlling a size and a shape of the distortion-eliminated first output beam, an object beam generator to generate an object beam by eliminating a distortion of the second output beam, and an object beam converging lens system to output a signal beam by modulating an object beam using a holographic element image, split the output signal beam in a plurality of directions, and converge split signal beams to be incident to a hologram film. The split signal beams may form an interference pattern through interference with the reference beam.

The hologram recording apparatus may further include a film transfer unit to transfer the hologram film based on locations of incidence of the split signal beams.

The object beam converging lens system may include an SLM to output a signal beam by modulating an object beam using a plurality of holographic element images, a PBS to transmit the object beam to the SLM, a BS to split the output signal beam in a plurality of directions, a relay lens to control sizes of signal beams split by the BS, and a converging lens to converge the size-controlled signal beams to be incident to a hologram film.

The object beam converging lens system may include an SLM to output a signal beam by modulating object beam using a plurality of holographic element images, a BS to split the output signal beam in a plurality of directions, a relay lens to control sizes of signal beams split by the BS, and a converging lens to converge the size-controlled signal beams to be incident to a hologram film.

The hologram recording apparatus may further include a controller to transmit a plurality of holographic element images to a single SLM.

The reference beam generator may split the reference beam to be incident to a hologram film based on a number and directions of the split signal beams.

According to yet another aspect of the present invention, there is also provided a hologram recording method including displaying a plurality of holographic element images by a single SLM, generating a reference beam and an object beam by splitting a source beam, and transferring a hologram film. The generating may include outputting a signal beam by modulating the object beam using the plurality of holographic element images, and splitting the output signal beam in a plurality of directions to be incident to the hologram film, and the transferring may include transferring the hologram film to a location at which an interference pattern is to be formed by the split signal beams through interference with the reference beam.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a hologram recording apparatus according to an embodiment of the present invention;

FIG. 2 illustrates an example of a hologram recording apparatus according to an embodiment of the present invention;

FIG. 3 illustrates a configuration of an object beam converging lens system included in a hologram recording apparatus according to a related art;

FIG. 4 illustrates an object beam converging lens system disposed on a hologram film according to an embodiment of the present invention;

FIG. 5 illustrates an example of a screen on which holographic element images are displayed by a spatial light modulator (SLM) according to an embodiment of the present invention;

FIG. 6 illustrates an example of an image provided to an object beam converging lens system by a controller according to an embodiment of the present invention;

FIG. 7 illustrates an example of an object beam converging lens system according to an embodiment of the present invention;

FIG. 8 illustrates a method of an object beam converging lens system splitting a signal beam using a quadrant beam splitter (QBS) according to an embodiment of the present invention;

FIG. 9 illustrates a method of an object beam converging lens system splitting a signal beam using a doublet beam splitter (DBS) according to an embodiment of the present invention;

FIG. 10 illustrates another example of an object beam converging lens system according to an embodiment of the present invention;

FIG. 11 illustrates an example of a method of the object beam converging lens system of FIG. 10 splitting a signal beam using a QBS;

FIG. 12 illustrates an example of a method of the object beam converging lens system of FIG. 10 splitting a signal beam using a DBS; and

FIG. 13 illustrates a hologram recording method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A hologram recording method according to an embodiment of the present invention may be performed by a hologram recording apparatus.

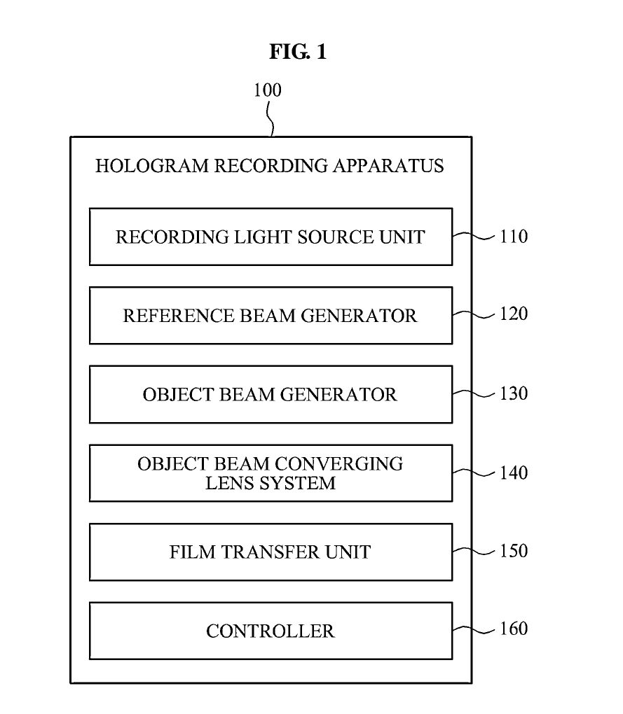

FIG. 1 illustrates a hologram recording apparatus 100 according to an embodiment of the present invention.

Referring to FIG. 1, the hologram recording apparatus 100 may include a recording light source unit 110, a reference beam generator 120, an object beam generator 130, an object beam converging lens system 140, a film transfer unit 150, and a controller 160.

The hologram recording apparatus 100 may partition a hologram film into a plurality of regions, and at least one object beam converging lens system 140 may be disposed in each partitioned region.

The recording light source unit 110 may split a source beam output from a light source into a first output beam and a second output beam and output the first output beam and the second output beam. The recording light source unit 110 may include a coherence light source, for example a laser. For example, the recording light source unit 110 may use a red (R) laser, a green (G) laser, and a blue (B) laser as light sources. A type of a laser used as a light source by the recording light source unit 110 may correspond to a continuous wave (CW) laser.

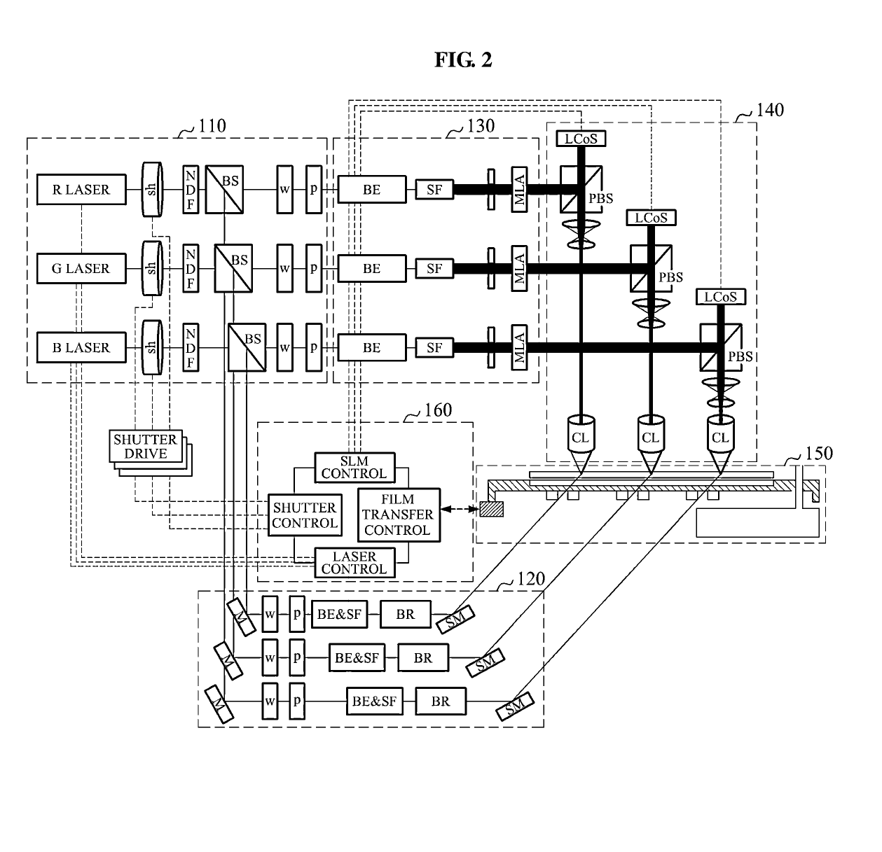

When an optical axis of the first output beam and the second output beam output to the reference beam generator 120 and the object beam generator 130 corresponds to a single optical axis, the recording light source unit 110 may combine source beams output by the R laser, the G laser, and the B laser into a single light using a beam combiner, and split the single light into a first output beam and a second output beam. The recording light source unit 110 may individually split the source beams output by the R laser, the G laser, and the B laser, as illustrated in FIG. 2.

The reference beam generator 120 may eliminate a distortion of the first output beam. The reference beam generator 120 may generate a reference beam by controlling a size and a shape of the distortion-eliminated first output beam.

The reference beam generator 120 may control the size of the distortion-eliminated first output beam using at least one mirror, at least one wave plate, and at least one polarizer, or control the size of the distortion-eliminated first output beam using a relay lens. The reference beam generator 120 may control the shape of the distortion-eliminated first output beam using an aperture.

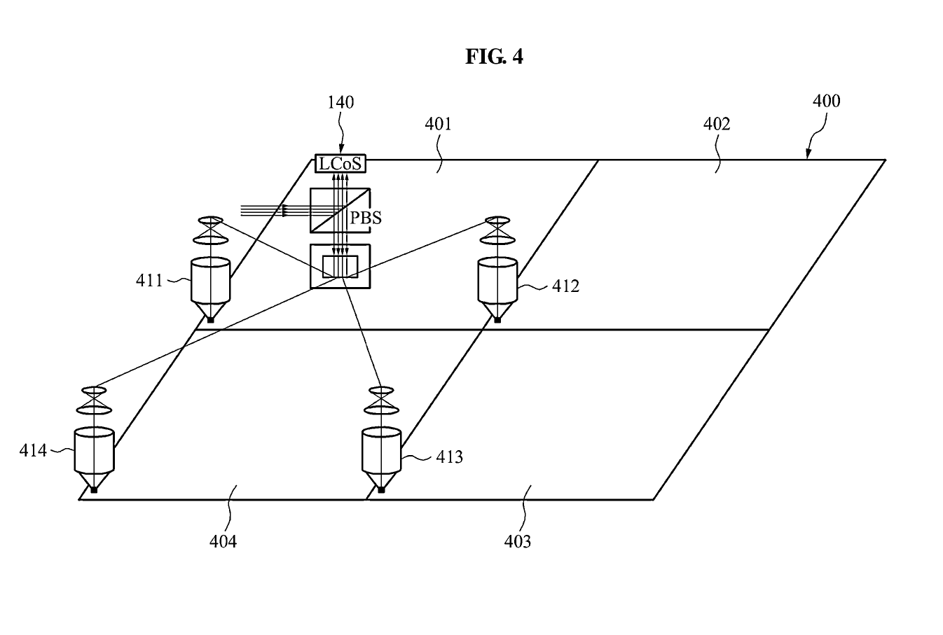

A configuration of the reference beam generator 120 will be described in detail with reference to FIG. 4.

The object beam generator 130 may generate an object beam being a collimated beam obtained by eliminating a distortion from the second output beam output by the recording light source unit 110.

The object beam generator 130 may generate the object beam by eliminating a distortion of the second output beam using a beam expander (BE), a spatial filter (SF), and a micro lens array (MLA). The object beam generator 130 may include a polarizer, a wave plate, and a neutral density filter (NDF) to adjust an intensity of the generated object beam.

The at least one object beam converging lens system 140 may output a signal beam by modulating the generated object beam using a holographic element image provided by the controller 160. The at least one object beam converging lens system 140 may converge the signal beam to be incident to a hologram film.

The signal beam incident to the hologram film may form an interference pattern through interference with the reference beam incident to the hologram film, whereby a hologram may be recorded on the hologram film.

The object beam converging lens system 140 may include a spatial light modulator (SLM), a relay lens, and a converging lens for each object beam output by the object beam generator 130.

The object beam converging lens system 140 may include one of a reflective SLM and a transmissive SLM. When the object beam converging lens system 140 includes a reflective SLM, the object beam converging lens system 140 may further include a polarized beam splitter (PBS) to transmit the object beam output by the object beam generator 130 to the SLM.

The SLM may display a holographic element image received from the controller 160 on a display. The object beam incident to the SLM may be modulated and reflected based on the holographic element image displayed on the display. A signal beam being the modulated and reflected object beam may proceed in a direction of a hologram film. For example, the signal beam may correspond to an object beam modulated to have an intensity of each pixel in a holographic element image.

When the object beam converging lens system 140 includes a transmissive SLM, the object beam output by the object beam generator 130 may be modulated and changed to a signal beam while penetrating through the SLM, and the signal beam may be incident to the relay lens.

The SLM may display a holographic element image received from the controller 160 on a transparent display through which an object beam may penetrate. The object beam output by the object beam generator 130 may be modulated using the holographic element image displayed on the transparent display while penetrating through the transparent display of the SLM.

The relay lens may control a size of the signal beam being the object beam modulated by the SLM. The size of the signal beam may correspond to a diameter of the signal beam. For example, when a holographic element having a size of 1 millimeter (mm)×1 mm is to be recorded on a hologram film, a size of a signal beam to be incident to a surface of the hologram film is to be 1 mm×1 mm. However, a size of a signal beam output by the SLM may not correspond to 1 mm×1 mm Thus, the relay lens may control the size of the signal beam output by the SLM based on the size of the hologram element.

A type of the relay lens may be determined based on the size of the holographic element to be recorded on the hologram film and the size of the signal beam output by the SLM.

When the size of the holographic element is smaller than the size of the signal beam output by the SLM, the object beam converging lens system 140 may include a relay lens configured to reduce a size of a signal beam. When the size of the holographic element is greater than the size of the signal beam output by the SLM, the object beam converging lens system 140 may include a relay lens configured to increase a size of a signal beam.

Only when a signal beam incident to the relay lens corresponds to distortion-less collimated light, a distortion resulting from a change in size may be prevented.

The converging lens may receive the size-controlled signal beam, and converge the received signal beam at a field of view (FOV) angle to be incident to the hologram film.

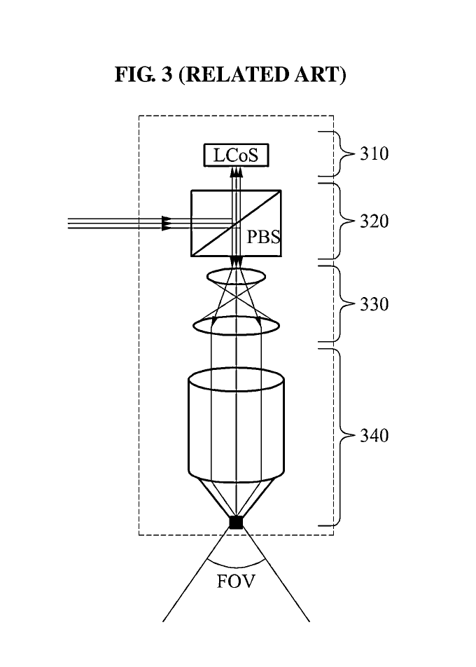

Configurations of the object beam converging lens system 140 will be described in detail with reference to FIGS. 3, 4, 7, and 10.

The film transfer unit 150 may transfer the hologram film to a location at which the at least one object beam converging lens system 140 is disposed. The film transfer unit 150 may transfer the hologram film within a range in which the at least one object beam converging lens system 140 is not disposed out of the partitioned region.

The at least one object beam converging lens system 140 disposed at the location to which the hologram film is transferred by the film transfer unit 150 may correspond to at least one object beam converging lens system 140 configured to output a signal beam using a holographic element image to be recorded on a hologram film.

The film transfer unit 150 may fix the hologram film, and transfer the fixed hologram film to the location at which the object beam converging lens system 140 is disposed. The film transfer unit 150 may include at least one axis transfer motor to transfer the hologram film.

Since the holographic element image may be two-dimensionally recorded on the hologram film, the film transfer unit 150 may include an X-axis motor and a Y-axis motor, in general. The film transfer unit 150 may further include a Z-axis motor to control a distance between the hologram film and the at least one object beam converging lens system 140 by adjusting a height of the film transfer unit 150.

The film transfer unit 150 may transfer the hologram film using one of a step method, a roll-fed method, and a scanning method.

The controller 160 may control operations of the recording light source unit 110, the reference beam generator 120, the object beam generator 130, and the object beam converging lens system 140, and the film transfer unit 150.

For example, the controller 160 may drive the recording light source unit 110 to output the first output beam and the second output beam to the reference beam generator 120 and the object beam generator 130, respectively. The controller 160 may control an optical shutter to control exposures of an object beam and a reference beam.

The controller 160 may transmit holographic element images corresponding to each partitioned region to the at least one object beam converging lens system 140 disposed in each partitioned region. The at least one object beam converging lens system 140 may modulate an object beam by outputting the holographic element images received from the controller 160 to the SLM, and outputting the objet beam generated by the object beam generator 130.

The controller 160 may control a motor of the film transfer unit 150 to transfer the hologram film to a location of a desired object beam converging lens system 140. The controller 160 may additionally have a control function to control an optical component and photograph a beam.

The hologram recording apparatus 100 may set a plurality of regions by partitioning a hologram film, and dispose at least one object beam converging lens system 140 in each set region, thereby recording a plurality of holographic element images simultaneously on the hologram film.

FIG. 2 illustrates an example of the hologram recording apparatus 100 according to an embodiment of the present invention.

Referring to FIG. 2, the recording light source unit 110 of the hologram recording apparatus 100 may split each of red light, green light, and blue light output by an R laser, a G laser, and a B laser into a first output beam and a second output beam. The recording light source unit 110 may output the first output beam to the reference beam generator 120, and output the second output beam to the object beam generator 130.

The recording light source unit 110 may adjust quantities of the red light, the green light, and the blue light using optical shutters indicated by sh, or adjust an intensity of at least one of the red light, the green light, the blue light, the first output beam, and the second output beam using NDFs, wave plates indicated by w, and polarizers indicated by p.

An open and close time of an optical shutter may be controlled through a shutter control of the controller 160 using software. However, when the optical shutter is controlled using software, an accuracy may decrease since the open and close time is dependent on a logical timer of the controller 160. Thus, the recording light source unit 110 may increase the accuracy using hardware, for example, a shutter drive that may precisely adjust the open and close time of the optical shutter.

An NDF of the recording light source unit 110 may include a 360-degree rotating continuous variable filter. However, when a profile of the red light, the green light, the blue light, the first output beam, or the second output beam is not uniform, the recording light source unit 110 may replace the NDF with a combination of a wave plate and a polarizer to adjust an intensity of the red light, the green light, the blue light, the first output beam, or the second output beam.

The recording light source unit 110 may split each of the red light, the green light, and the blue light into a first output beam and a second output beam using a BS that splits a beam irrespective of a polarization, or using a BS that splits a beam based on a polarization direction.

The reference beam generator 120 may generate a reference beam based on the first output beam output by the recording light source unit 110, and transmit the generated reference beam to a hologram film fastened to the film transfer unit 150.

The reference beam generator 120 may expand the first output beam using a BE & SF, and generate the reference beam from the expanded first output beam using a beam reducer (BR) and other optical devices.

The object beam generator 130 may generate an object beam based on the second output beam output by the recording light source unit 110, and output the generated object beam to the object beam converging lens system 140.

The object beam generator 130 may generate the object beam by eliminating a distortion of the second output beam using a BE, an SF, and an MLA, as illustrated in FIG. 2.

The BE and the SF may generate the object beam by eliminating the distortion of the second output beam output by the recording light source unit 110. The object beam generated by the BE and the SF may have a Gaussian distribution and a nonuniform shape. Thus, the MLA may correct the shape of the object beam generated by the BE and the SF to be uniform, and output the shape-corrected object beam. In this example, the MLA may correspond to an MLA selected based on a pixel pitch and a diameter of a beam required by an SLM of the object beam converging lens system 140.

The object beam converging lens system 140 may display a holographic element image on a liquid crystal on display (LCoS) of the SLM, output a signal beam by modulating the object beam using the displayed holographic element image, and converge the output signal beam to be incident to the hologram film. The SLM included in the object beam converging lens system 140 may correspond to a transmissive SLM or a reflective SLM.

The signal beam incident from the object beam converging lens system 140 may form an interference pattern on the hologram film through interference with the reference beam incident from the reference bam generator 120.

The controller 160 may control an optical component, a stage of the film transfer unit 150, and the SLM in a preset sequence so that signal beams may sequentially be incident to the hologram film using a holographic element image during a hologram recording process.

For example, the controller 160 may deliver a shuttering speed to the shutter drive to enable a shutter to be open for a desired period of time, thereby controlling the optical shutter of the recording light source unit 110. The controller 160 may provide the holographic element image to the SLM while the optical shutter is open. The operation of the controller 160 providing the holographic element image to the SLM may be implemented through interfacing between a personal computer (PC) and the shutter drive, and may interoperate using other interfaces including a digital visual interface (DVI). The controller 160 may control outputs of the R laser, the G laser, and the B laser of the recording light source unit 110 using software, thereby controlling intensities of the lasers without use of an optical device.

FIG. 3 illustrates a configuration of an object beam converging lens system included in a hologram recording apparatus according to a related art.

In detail, FIG. 3 illustrates the configuration of the object beam converging lens system including a reflective SLM to transmit an object beam to a hologram film, among object beam converging lens systems included in the hologram recording apparatus according to the related art.

Referring to FIG. 3, a PBS 320 may reflect an object beam output by the object beam generator 130 in a vertical direction to be incident to an LCoS 310 of an SLM.

The SLM may display, on the LCoS 310, hologram element images received from the controller 160. The incident object beam may be reflected on the LCoS 310 of the SLM to proceed in a direction of the hologram film. The reflected object beam may be modulated using the holographic element images displayed on the LCoS 310. The LCoS 310 of the SLM may output a signal beam being the object beam modulated using the holographic element images.

A relay lens 330 may reduce a size of the output signal beam based on a size of a preset holographic element.

A converging lens 340 may converge the size-reduced signal beam at an FOV angle to be incident to the hologram film.

As illustrated in FIG. 3, in the object beam converging lens system included in the hologram recording apparatus according to the related art, the converging lens 340 that transmits the signal beam to the hologram film may be in a one-to-one correspondence with the LCoS 310 of the SLM. Thus, when a plurality of signal beams is to be incident to the hologram film simultaneously, LCoSs of the SLM corresponding to a number of the signal beams to be incident to the hologram film may be required.

FIG. 4 illustrates the object beam converging lens system 140 disposed on a hologram film according to an embodiment of the present invention.

Referring to FIG. 4, the hologram recording apparatus 100 may partition a hologram film 400 into a first region 401, a second region 402, a third region 403, and a fourth region 404. The hologram recording apparatus 100 may dispose converging lenses in the respective regions to record four object beams on the hologram film 400 simultaneously.

The object beam converging lens system 140 may include a first converging module 411 to transmit an object beam to the first region 401, a second converging module 412 to transmit the object beam to the second region 402, a third converging module 413 to transmit the object beam to the third region 403, and a fourth converging module 414 to transmit the object beam to the fourth region 404.

The object beam converging lens system 140 may split a signal beam output by an LCoS of an SLM into four signal beams to be incident to the first converging module 411, the second converging module 412, the third converging module 413, and the fourth converging module 414, thereby transmitting the plurality of signal beams to the hologram film 400 using the single LCoS.

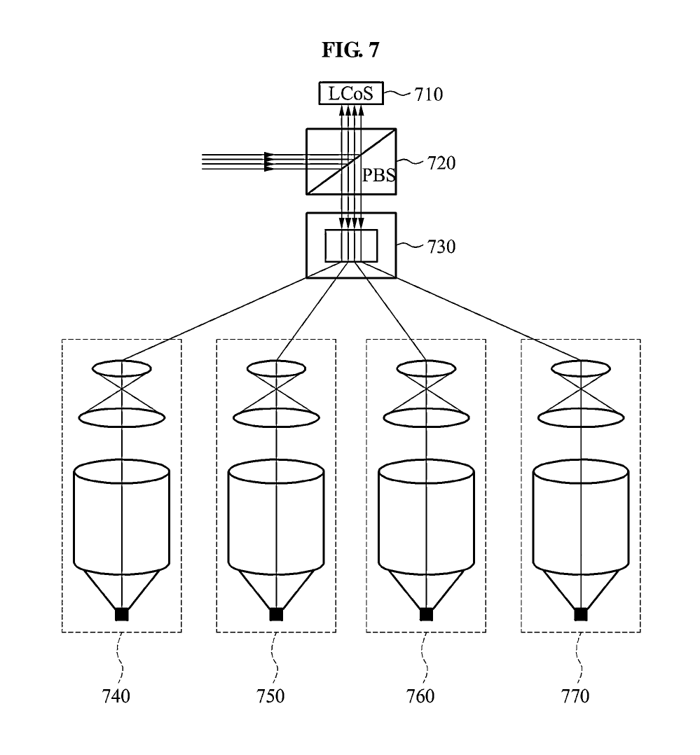

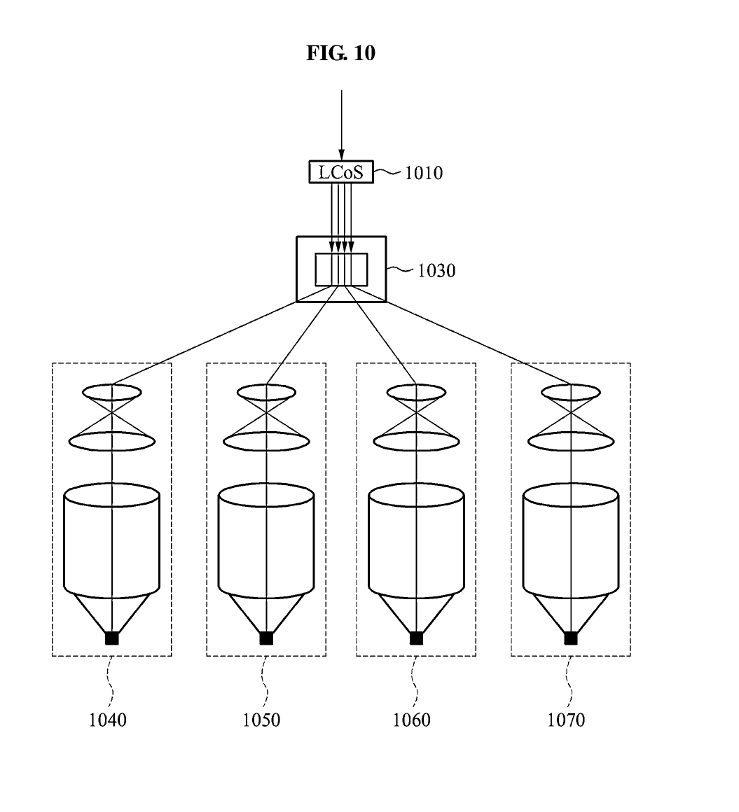

Configurations of the object beam converging lens system 140 will be further described in detail with reference to FIGS. 7 and 10.

The hologram recording apparatus 100 may split, using the reference beam generator 120, a reference beam based on a number of the converging modules of the object beam converging lens system 140 and transmit split reference beams to the hologram film.

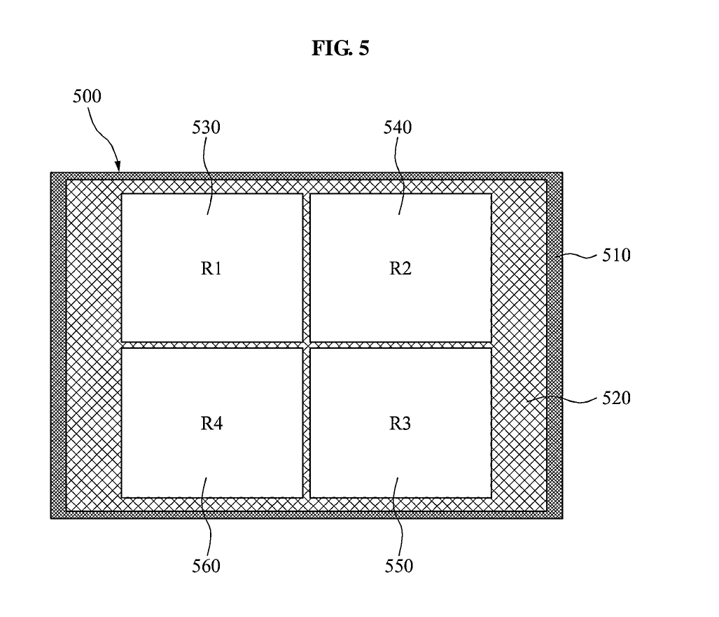

FIG. 5 illustrates an example of a screen on which holographic element images are displayed by an SLM according to an embodiment of the present invention.

Referring to FIG. 5, holographic element images received from the controller 160 may be displayed on the screen by an LCoS 500 of the SLM.

The SLM may receive, from the controller 160, a holographic element image R1 530 corresponding to the first region 401, a holographic element image R2 540 corresponding to the second region 402, a holographic element image R3 550 corresponding to the third region 403, and a holographic element image R4 560 corresponding to the fourth region 404.

The SLM may partition an area of effective pixels 520 disposed within a bezel 510 of the LCoS 500 into four regions. The SLM may display the holographic element image R1 530, the holographic element image R2 540, the holographic element image R3 550, and the holographic element image R4 560 in the partitioned regions, respectively, as shown in FIG. 5.

A signal beam output by the SLM may include a first signal beam output by modulating an object beam using the holographic element image R1 530, a second signal beam output by modulating the object beam using the holographic element image R2 540, a third signal beam output by modulating the object beam using the holographic element image R3 550, and a fourth signal beam output by modulating the object beam using the holographic element image R4 560.

The object beam converging lens system 140 may split the signal beam including the first signal beam, the second signal beam, the third signal beam, and the fourth signal beam, and transmit the split signal beams to the first converging module 411, the second converging module 412, the third converging module 413, and the fourth converging module 414, respectively, thereby transmitting the four signal beams to the hologram film using the single LCoS 500.

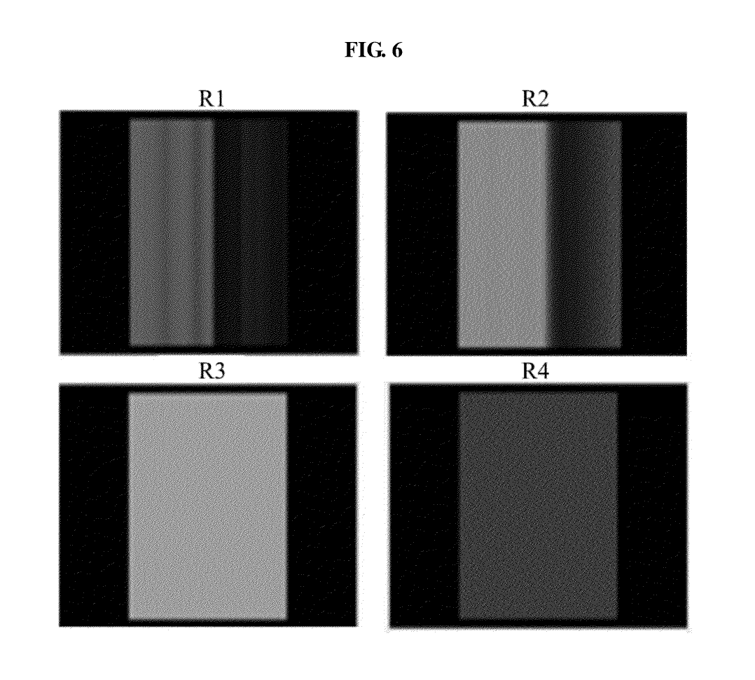

FIG. 6 illustrates an example of an image provided to an object beam converging lens system by a controller according to an embodiment of the present invention.

Referring to FIG. 6, the controller 160 of the hologram recording apparatus 100 may transfer holographic element images R1, R2, R3, and R4 to be displayed by a single SLM as a single image frame.

The SLM may display the received holographic element images R1, R2, R3, and R4 on a single LCoS. The SLM may set boundary pixels among the holographic element images R1, R2, R3, and R4, thereby minimizing interference among signal beams when a BS of the object beam converging lens system splits a signal beam into a first signal beam corresponding to the holographic element image R1, a second signal beam corresponding to the holographic element image R2, a third signal beam corresponding to the holographic element image R3, and a fourth signal beam corresponding to the holographic element image R4.

FIG. 7 illustrates an example of the object beam converging lens system 140 according to an embodiment of the present invention.

In detail, FIG. 7 illustrates an example of the object beam converging lens system 140 using a reflective SLM.

Referring to FIG. 7, the object beam converging lens system 140 may include an SLM 710 including an LCoS, a PBS 720, a BS 730, a first converging module 740, a second converging module 750, a third converging module 760, and a fourth converging module 770.

The SLM 710 may display a plurality of holographic element images on the LCoS to modulate an object beam incident from the PBS 720. The SLM 710 may display the plurality of holographic element images on the LCoS, as illustrated in FIG. 5. The SLM 710 may output a signal beam being the modulated object beam.

The PBS 720 may transmit, to the SLM 710, an object beam incident from the object beam generator 130.

The BS 730 may split the signal beam output by the SLM 710 in a plurality of directions. The BS 730 may split the signal beam output by the SLM 710 into four signal beams based on the plurality of holographic element images displayed by the SLM 710. The BS 730 may transmit the four split signal beams to the first converging module 740, the second converging module 750, the third converging module 760, and the fourth converging module 770 disposed in different directions, respectively.

The BS 730 may split the signal beam in directions other than an optical axis along which the signal beam output by the SLM 710 proceeds.

In an example, the BS 730 may split the signal beam using the holographic element images in up, down, left, and right directions using a quadrant beam splitter (QBS) configured to split a beam in four directions.

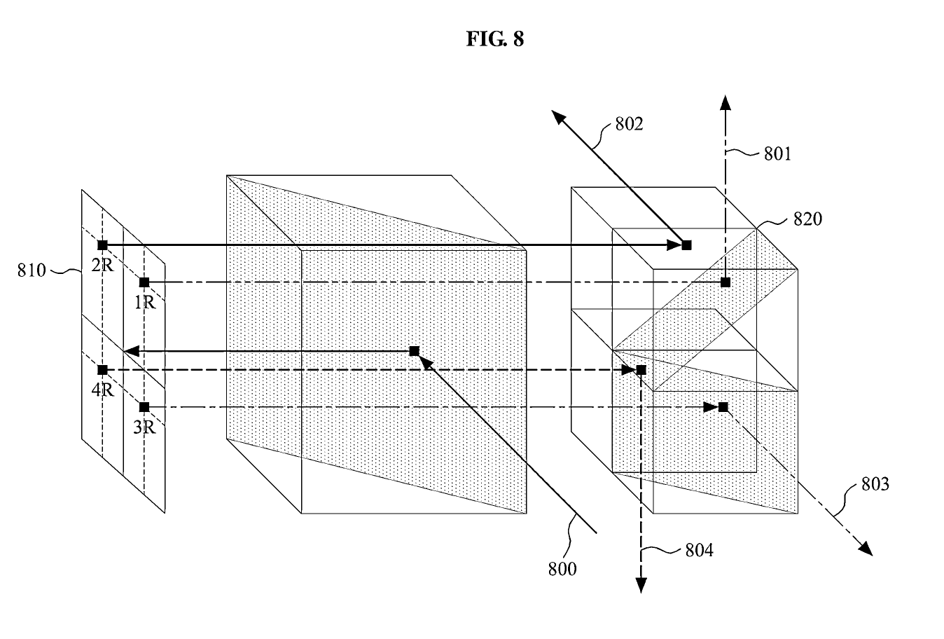

A method of the BS 730 splitting a signal beam using a QBS will be described in detail with reference to FIG. 8.

In another example, the BS 730 may split the signal beam into a first signal beam and a second signal beam. The BS 730 may split the signal beam using the holographic element images in left and right directions using a doublet beam splitter (DBS) configured to polarize a first signal beam and a second signal beam in different directions.

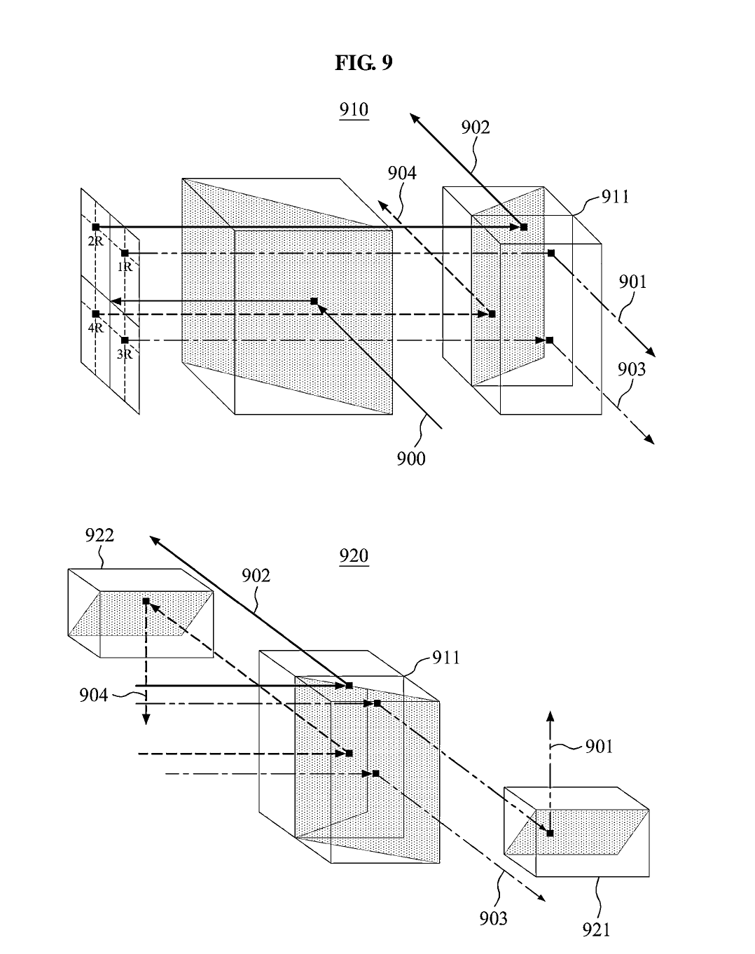

A method of the BS 730 splitting a signal beam using a DBS will be described in detail with reference to FIG. 9.

The first converging module 740 may control a size of one of the signal beams split by the BS 730 using a relay lens, and converge the size-controlled signal beam to be incident to a first region of a hologram film using a converging lens.

The second converging module 750 may control a size of another of the signal beams split by the BS 730 using a relay lens, and converge the size-controlled signal beam to be incident to a second region of the hologram film using a converging lens.

The third converging module 760 may control a size of still another of the signal beams split by the BS 730 using a relay lens, and converge the size-controlled signal beam to be incident to a third region of the hologram film using a converging lens.

The fourth converging module 770 may control a size of yet another of the signal beams split by the BS 730 using a relay lens, and converge the size-controlled signal beam to be incident to a fourth region of the hologram film using a converging lens.

FIG. 8 illustrates a method of the object beam converging lens system 140 splitting a signal beam using a QBS 820 according to an embodiment of the present invention.

The QBS 820 of the BS 730 may include an optical filter configured to split an object beam in a preset direction. For example, referring to FIG. 8, the QBS 820 may include optical filters disposed in different diagonal directions to reflect an object beam.

An object beam 800 may be incident from a PBS to an SLM. The SLM may partition an LCoS 810 into regions 1R, 2R, 3R, and 4R to display holographic elements images therein. The SLM may display a holographic element image R1, a holographic element image R2, a holographic element image R3, and a holographic element image R4 in the regions 1R, 2R, 3R, and 4R of the LCoS 810, respectively.

A signal beam corresponding to the holographic element image R1, a signal beam corresponding to the holographic element image R2, a signal beam corresponding to the holographic element image R3, and a signal beam corresponding to the holographic element image R4 may be split by the QBS 820 in different directions.

For example, a signal beam 801 being an object beam modulated using the holographic element image R1 may be reflected in a north direction by a filter of the QBS 820 disposed in a northeast direction. A signal beam 802 being an object beam modulated using the holographic element image R2 may be reflected in a west direction by a filter of the QBS 820 disposed in a northwest direction.

A signal beam 803 being an object beam modulated using the holographic element image R3 may be reflected in an east direction by a filter of the QBS 820 disposed in a southeast direction. A signal beam 804 being an object beam modulated using the holographic element image R4 may be reflected in a south direction by a filter of the QBS 820 disposed in a southwest direction.

The signal beams corresponding to the holographic element images may be split based on the holographic element images and reflected in different directions, thereby being incident to four regions of a hologram film.

FIG. 9 illustrates a method of the object beam converging lens system 140 splitting a signal beam using a DBS 911 according to an embodiment of the present invention.

The DBS 911 of the BS 730 may split an incident signal beam into two signal beams and reflect the signal beams in different directions. However, since an SLM displays four holographic element images, the BS 730 may need to split the signal beam into four signal beams.

Thus, the BS 730 may further include a first additional BS 921 and a second additional BS 922 to split each of the two signal beams split by the DBS 911 into two signal beams.

The DBS 911 of the BS 730 may split the signal beam output by the SLM into a first signal beam and a second signal beam, and polarize the first signal beam and the second signal beam in different directions. The first additional BS 921 may split the first signal beam into a third signal beam and a fourth signal beam, and polarize the third signal beam and the fourth signal beam in different directions. The second additional BS 922 may split the second signal beam into a fifth signal beam and a sixth signal beam, and polarize the fifth signal beam and the sixth signal beam in different directions.

The first additional BS 921 and the second additional BS 922 may polarize a portion of signal beams split from the first signal beam and the second signal beam in different directions, thereby splitting the first signal beam and the second signal beam.

In operation 910, an object beam 900 may be incident from a PBS to an SLM. The SLM may display a holographic element image R1, a holographic element image R2, a holographic element image R3, and a holographic element image R4 in partitioned regions 1R, 2R, 3R, and 4R of an LCoS, respectively.

A signal beam 901 being an object beam modulated using the holographic element image R1 and a signal beam 903 being an object beam modulated using the holographic element image R3 may be reflected by the DBS 911 in an east direction. A signal beam 902 being an object beam modulated using the holographic element image R2 and a signal beam 904 being an object beam modulated using the holographic element image R4 may be reflected by the DBS 911 in a west direction.

In operation 920, the signal beam 901 may be reflected by the first additional BS 921 in a north direction. The signal beam 903 may continuously proceed in the east direction in which the signal beam 903 is reflected by the DBS 911. The BS 730 may reflect only the signal beam 901 between the signal beam 901 and the signal beam 903 reflected by the DBS 911, thereby splitting and polarizing the signal beam 901 and the signal beam 903 in different directions.

In addition, the signal beam 904 may be reflected by the second additional BS 922 in a south direction. The signal beam 902 may continuously proceed in the west direction in which the signal beam 902 is reflected by the DBS 911. The BS 730 may reflect only the signal beam 904 between the signal beam 902 and the signal beam 904, thereby splitting and polarizing the signal beam 902 and the signal beam 904 in different directions.

In this example, the direction in which the signal beam 901 is reflected by the first additional BS 921 may differ from the direction in which the signal beam 904 is reflected by the second additional BS 922.

The signal beams corresponding to the holographic element images may be split based on the holographic element images and reflected in different directions, thereby being incident to four regions of a hologram film.

FIG. 10 illustrates another example of the object beam converging lens system 140 according to an embodiment of the present invention.

In detail, FIG. 10 illustrates an example of the object beam converging lens system 140 using a transmissive SLM.

Referring to FIG. 10, the object beam converging lens system 140 may include an SLM 1010 including an LCoS, a BS 1030, and a first converging module 1040, a second converging module 1050, a third converging module 1060, and a fourth converging module 1070.

The SLM 1010 may display a plurality of holographic element images on the transparent LCoS. An object beam incident from the object beam generator 130 may be modulated using the plurality of holographic images while penetrating through the transparent LCoS.

The BS 1030 may split a signal beam being the object beam modulated by the SLM 1010 in a plurality of directions. The BS 730 may split the signal beam output by the SLM into four signal beams based on the plurality of holographic element images displayed by the SLM 1010. The BS 1030 may transmit the four split signal beams to the first converging module 1040, the second converging module 1050, the third converging module 1060, and the fourth converging module 1070 disposed in different directions, respectively.

The BS 1030 may split the signal beam in directions other than an optical axis along which the signal beam output by the SLM 1010 proceeds.

In an example, the BS 1030 may split the signal beam using the holographic element images in up, down, left, and right directions using a QBS configured to split a beam in four directions.

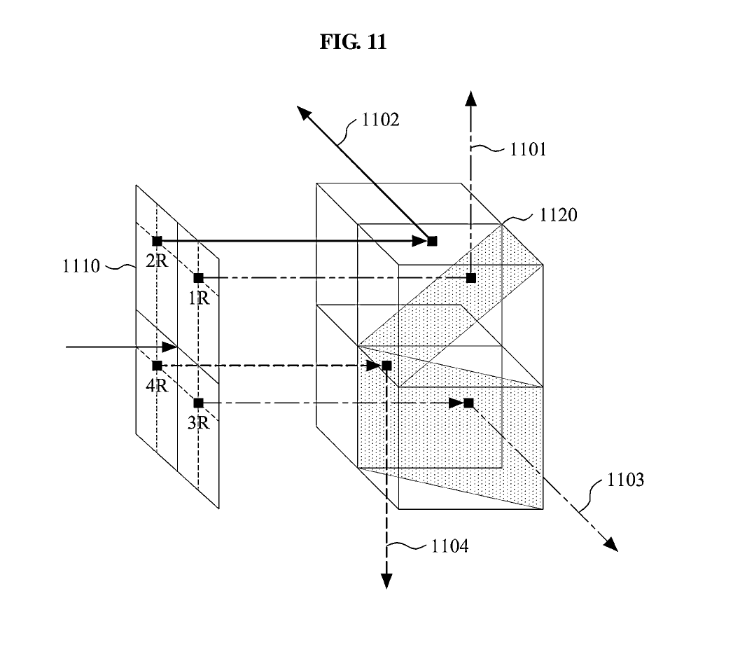

A method of the BS 1030 splitting a signal beam using a QBS will be described in detail with reference to FIG. 11.

In another example, the BS 1030 may split the signal beam into a first signal beam and a second signal beam. The BS 1030 may split the signal beam using the holographic element images in left and right directions using a DBS configured to polarize a first signal beam and a second signal beam in different directions.

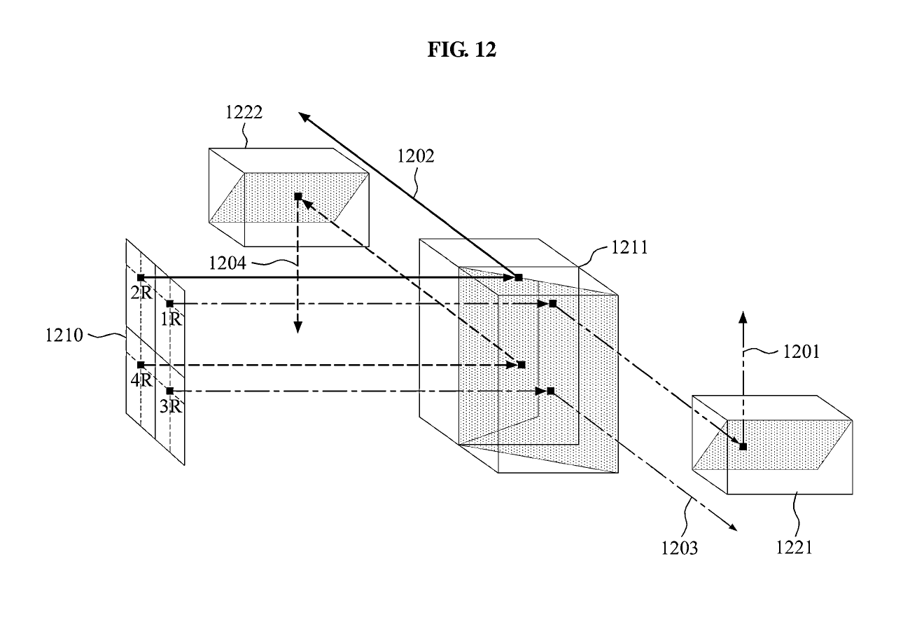

A method of the BS 1030 splitting a signal beam using a DBS will be described in detail with reference to FIG. 12.

The first converging module 1040 may control a size of one of the signal beams split by the BS 1030 using a relay lens, and converge the size-controlled signal beam to be incident to a first region of a hologram film using a converging lens.

The second converging module 1050 may control a size of another of the signal beams split by the BS 1030 using a relay lens, and converge the size-controlled signal beam to be incident to a second region of the hologram film using a converging lens.

The third converging module 1060 may control a size of still another of the signal beams split by the BS 1030 using a relay lens, and converge the size-controlled signal beam to be incident to a third region of the hologram film using a converging lens.

The fourth converging module 1070 may control a size of yet another of the signal beams split by the BS 1030 using a relay lens, and converge the size-controlled signal beam to be incident to a fourth region of the hologram film using a converging lens.

FIG. 11 illustrates an example of a method of the object beam converging lens system 140 of FIG. 10 splitting a signal beam using a QBS 1120.

An object beam may penetrate through a transparent LCoS 1110 of an SLM. The SLM may display a holographic element image R1, a holographic element image R2, a holographic element image R3, and a holographic element image R4 in regions 1R, 2R, 3R, and 4R of the LCoS 1110, respectively.

The object beam penetrating through the transparent LCoS 1110 may be modulated using a holographic element image displayed at a location through which the object beam penetrates.

A signal beam corresponding to the holographic element image R1, a signal beam corresponding to the holographic element image R2, a signal beam corresponding to the holographic element image R3, and a signal beam corresponding to the holographic element image R4 may be split by the QBS 1120 in different directions.

For example, a signal beam 1101 being an object beam modulated using the holographic element image R1 may be reflected in a north direction by a filter of the QBS 1120 disposed in a northeast direction. A signal beam 1102 being an object beam modulated using the holographic element image R2 may be reflected in a west direction by a filter of the QBS 1120 disposed in a northwest direction.

A signal beam 1103 being an object beam modulated using the holographic element image R3 may be reflected in an east direction by a filter of the QBS 1120 disposed in a southeast direction. A signal beam 1104 being an object beam modulated using the holographic element image R4 may be reflected in a south direction by a filter of the QBS 1120 disposed in a southwest direction.

The signal beams corresponding to the holographic element images may be split based on the holographic element images and reflected in different directions, thereby being incident to four regions of a hologram film.

FIG. 12 illustrates an example of a method of the object beam converging lens system 140 of FIG. 10 splitting a signal beam using a DBS 1211.

An object beam may penetrate through a transparent LCoS 1210 of an SLM. The SLM may display a holographic element image R1, a holographic element image R2, a holographic element image R3, and a holographic element image R4 in regions 1R, 2R, 3R, and 4R of the LCoS 1210, respectively.

The object beam penetrating through the transparent LCoS 1210 may be modulated using a holographic element image displayed at a location through which the object beam penetrates.

A signal beam 1201 being an object beam modulated using the holographic element image R1 and a signal beam 1203 being an object beam modulated using the holographic element image R3 may be reflected by the DBS 1211 in an east direction. A signal beam 1202 being an object beam modulated using the holographic element image R2 and a signal beam 1204 being an object beam modulated using the holographic element image R4 may be reflected by the DBS 1211 in a west direction.

The signal beam 1201 may be reflected by a first additional BS 1221 in a north direction. The signal beam 1203 may continuously proceed in the east direction in which the signal beam 1203 is reflected by the DBS 1211. The BS 1030 may reflect only the signal beam 1201 between the signal beam 1201 and the signal beam 1203 reflected by the DBS 1211, thereby splitting and polarizing the signal beam 1201 and the signal beam 1203 in different directions.

In addition, the signal beam 1204 may be reflected by a second additional BS 1222 in a south direction. The signal beam 1202 may continuously proceed in the west direction in which the signal beam 1202 is reflected by the DBS 1211. The BS 1030 may reflect only the signal beam 1204 between the signal beam 1202 and the signal beam 1204, thereby splitting and polarizing the signal beam 1202 and the signal beam 1204 in different directions.

In this example, the direction in which the signal beam 1201 is reflected by the first additional BS 1221 may differ from the direction in which the signal beam 1204 is reflected by the second additional BS 1222.

The signal beams corresponding to the holographic element images may be split based on the holographic element images and reflected in different directions, thereby being incident to four regions of a hologram film.

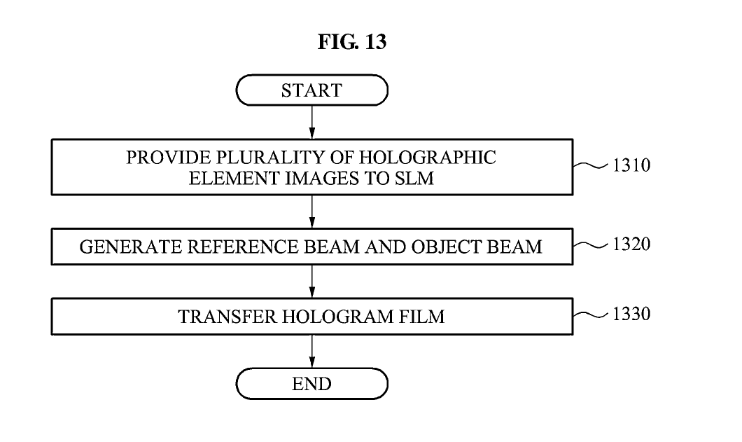

FIG. 13 illustrates a hologram recording method according to an embodiment of the present invention.

In operation 1310, the controller 160 may provide a plurality of holographic element images to a single SLM. The SLM may display the plurality of holographic element images on a single LCoS.

In operation 1320, the controller 160 may control the recording light source unit 110 to generate an object beam and a reference beam. The controller 160 may control a shutter of the recording light source 110 to transmit a source beam output by a laser to a BS. The source beam transmitted to the BS may be split into a first output beam and a second output beam, and the first output beam and the second output beam may be output to the reference beam generator 120 and the object beam generator 130, respectively.

The reference beam generator 120 may generate a reference beam using the first output beam and transmit the generated reference beam to a hologram film. The object beam generator 130 may generate an object beam using the second object beam, and output the generated object beam to the object beam converging lens system 140.

The object beam converging lens system 140 may output a signal beam by modulating the object beam using the holographic element images provided in operation 1310, split the output signal beam using the holographic element images, and transmit the split signal beams to the hologram film using a plurality of converging modules.

In operation 1330, the controller 160 may control the film transfer unit 150 to transfer the hologram film to a location at which a signal beam output in operation 1320 is to form an interference pattern through interference with the reference beam generated in operation 1320.

According to an embodiment of the present invention, it is possible to record a plurality of holographic element images on a hologram film using a single SLM by outputting a signal beam being an object beam modulated using the plurality of holographic element images using the single SLM, slitting the signal beam for each holographic element image, and transmitting the split signal beams to the hologram film.

In this example, hologram element images more than partitioned regions of the hologram film may be recorded simultaneously on the hologram film and thus, it is possible to increase a rate at which holographic element images are recorded, when compared to a related art in which a single holographic element image is recorded on a hologram film at a time.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A hologram recording apparatus comprising:
a spatial light modulator (SLM) to output a signal beam by modulating an object beam using a plurality of holographic element images;
a polarized beam splitter (PBS) to transmit the object beam to the SLM;
a beam splitter (BS) to split the output signal beam in a plurality of directions;
a relay lens to control sizes of signal beams split by the BS; and
a converging lens to converge the size-controlled signal beams to be incident to a hologram film.

2. The apparatus of claim 1, wherein the BS splits the output signal beam based on the plurality of holographic element images.

3. The apparatus of claim 1, wherein the BS splits the output signal beam in four directions except for an optical axis along which the output signal beam proceeds.

4. The apparatus of claim 1, wherein the BS splits the output signal beam in two directions except for an optical axis along which the output signal beam proceeds.

5. The apparatus of claim 4, further comprising:
a first additional BS to split one of the signal beams split by the BS in different directions; and
a second additional BS to split another of the signal beams split by the BS in different directions.

6. A hologram recording apparatus comprising:
a spatial light modulator (SLM) to output a signal beam by modulating object beam using a plurality of holographic element images;
a beam splitter (BS) to split the output signal beam in a plurality of directions;
a relay lens to control sizes of signal beams split by the BS; and
a converging lens to converge the size-controlled signal beams to be incident to a hologram film.

7. The apparatus of claim 6, wherein the BS splits the output signal beam based on the plurality of holographic element images.

8. The apparatus of claim 6, wherein the BS splits the output signal beam in four directions except for an optical axis along which the output signal beam proceeds.

9. The apparatus of claim 6, wherein the BS splits the output signal beam in two directions except for an optical axis along which the output signal beam proceeds.

10. The apparatus of claim 9, further comprising:
a first additional BS to split one of the signal beams split by the BS in different directions; and
a second additional BS to split another of the signal beams split by the BS in different directions.

11. A hologram recording apparatus comprising:
a recording light source unit to split a source beam output from a light source into a first output beam and a second output beam and output the first output beam and the second output beam;
a reference beam generator to eliminate a distortion of the first output beam, and generate a reference beam by controlling a size and a shape of the distortion-eliminated first output beam;
an object beam generator to generate an object beam by eliminating a distortion of the second output beam; and
an object beam converging lens system to output a signal beam by modulating an object beam using a holographic element image, split the output signal beam in a plurality of directions, and converge split signal beams to be incident to a hologram film,
wherein the split signal beams form an interference pattern through interference with the reference beam.

12. The apparatus of claim 11, further comprising:
a film transfer unit to transfer the hologram film based on locations of incidence of the split signal beams.

13. The apparatus of claim 11, wherein the object beam converging lens system comprises:
a spatial light modulator (SLM) to output a signal beam by modulating an object beam using a plurality of holographic element images;
a polarized beam splitter (PBS) to transmit the object beam to the SLM;
a beam splitter (BS) to split the output signal beam in a plurality of directions;
a relay lens to control sizes of signal beams split by the BS; and
a converging lens to converge the size-controlled signal beams to be incident to a hologram film.

14. The apparatus of claim 11, wherein the object beam converging lens system comprises:
a spatial light modulator (SLM) to output a signal beam by modulating object beam using a plurality of holographic element images;
a BS to split the output signal beam in a plurality of directions;
a relay lens to control sizes of signal beams split by the BS; and
a converging lens to converge the size-controlled signal beams to be incident to a hologram film.

15. The apparatus of claim 11, further comprising:
a controller to transmit a plurality of holographic element images to a single SLM.

16. The apparatus of claim 11, wherein the reference beam generator splits the reference beam to be incident to a hologram film based on a number and directions of the split signal beams.

17. A hologram recording method comprising:
displaying a plurality of holographic element images by a single spatial light modulator (SLM);
generating a reference beam and an object beam by splitting a source beam; and
transferring a hologram film,
wherein the generating comprises outputting a signal beam by modulating the object beam using the plurality of holographic element images, and splitting the output signal beam in a plurality of directions to be incident to the hologram film, and
the transferring comprises transferring the hologram film to a location at which an interference pattern is to be formed by the split signal beams through interference with the reference beam.

18. The method of claim 17, wherein the signal beam is split by a beam splitter (BS) in four directions except for an optical axis along which the output signal beam proceeds.

19. The method of claim 17, wherein the signal beam is split by a BS in two directions except for an optical axis along which the output signal beam proceeds.

20. The method of claim 19, wherein one of the signal beams split by the BS is split by a first additional BS in different directions, and
another of the signal beams split by the BS is split by a second additional BS in different directions.
